(19) United States
(12) Patent Application Publication
(10) Pub. No.: US 2008/0099053 A1
(43) Pub. Date: May 1, 2008

(54) WET/DRY VACUUM BAG

(76) Inventor: Michael Loveless, Price, UT (US)

Correspondence Address: RANDALL B. BATEMAN;BATEMAN IP LAW GROUP, 8 EAST BROADWAY, SUITE 550, PO BOX 1319, SALT LAKE CITY, UT, 84110, US

(21) Appl. No.: 11/559,328

(22) Filed: Nov. 13, 2006

Related U.S. Application Data
(60) Provisional application No. 60/863,769, filed on Oct. 31, 2006.

(51) Int. Cl. B01D 46/00; B08B 5/04

(52) U.S. Cl. 134/21; 55/373; 55/378

(57) ABSTRACT

A wet/dry vacuum bag may be used to collect both wet and dry debris without destruction of the bag and without loss in performance.

### RELATED APPLICATIONS

The present application claims the benefit of U.S. Provisional Application Ser. No. 60/863,769, filed Oct. 31, 2006, which is expressly incorporated herein.

### BACKGROUND OF THE INVENTION

1. The Field of the Invention

The present invention relates to vacuum bags. More specifically, the present invention relates to an improved vacuum bag which may be used to collect and contain both wet and dry materials.

2. State of the Art

Vacuums are commonly used to collect debris, typically for disposal. Portable canister vacuums, or shop vacuums, are increasingly common. These vacuums are often sold under the SHOP-VAC® trademark and other names. These vacuums typically have a canister, which often has a volume of about 10-15 gallons, and a canister lid which contains the vacuum motor and filter. The debris collects in the canister during use and is emptied by removing the lid and dumping out the canister. The canister typically has wheels on the bottom to allow a user to easily move the vacuum.

Some of these vacuums may be used wet or dry, and these models will typically have a drain in the bottom to allow the water to drain out. The vacuum may thus be used to collect spilled or standing water.

These vacuums are often inconvenient for wet use, however. For example, using the vacuum to collect mud or slurries fills the vacuum with contents which may be difficult to remove from the vacuum. Using the vacuum to collect dirt and dust and then liquids without emptying the vacuum likewise results in a vacuum filled with a difficult to remove mud. Often, these vacuums are used by contractors or workers to collect drywall dust, or the like. If such dust is then mixed with water in the vacuum, the resulting mud is somewhat difficult to clean out and will harden to a very hard solid.

Paper vacuum bags are available for these vacuums. These paper bags are often marketed as drywall bags, as persons collecting drywall dust need additional filtering capacity and easy cleanup and containment offered by the bags. These paper bags will deteriorate if used to collect water or wet debris, as the water degrades the paper binder, etc. These paper bags are also easily torn when filled with a heavy amount of dirt, such as drywall dust. While vacuum bags are available for dry substances, none are available for collecting wet materials. Wet materials are simply collected into the vacuum canister and later cleaned out.

There is thus a need for a vacuum bag which overcomes the limitations of available vacuum bags and filtration elements. Specifically, there is a need for a vacuum bag which is capable of receiving water and wet substances, and which allows a person to alternately collect dry or wet debris without regard to the prior contents of the vacuum.

### SUMMARY OF THE INVENTION

It is an object of the present invention to provide an improved vacuum bag.

According to one aspect of the invention, a vacuum bag is provided for collecting wet materials. The vacuum bag made of a filter material which is not adversely affected by water. The vacuum filter bag may thus be used to collect wet materials or water or other liquids.

According to another aspect of the invention, a disposable vacuum bag is provided. The vacuum bag may be simply be thrown away when filled. Available wet filters for canister vacuums are washable filter elements which typically need to be cleaned after use. Thus, a person using a canister vacuum to collect wet materials must clean the filter and clean out the canister. The present invention provides a disposable filter bag which eliminates the need to clean both a reusable filter and the vacuum canister. A person may collect liquids, wet materials, dry materials, etc. in the same vacuum bag without degradation of the bag or loss or performance.

These and other aspects of the present invention are realized in a wet/dry vacuum bag as shown and described in the following figure and related description.

### BRIEF DESCRIPTION OF THE DRAWINGS

Various embodiments of the present invention are shown and described in reference to the numbered drawings wherein:

FIG. 1 shows a front view of a vacuum bag of the present invention;

FIG. 2 shows a detailed view of the vacuum bag of FIG. 1; and

FIG. 3 shows a top view of the canister of a canister vacuum having the vacuum bag of the present invention therein.

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity.

### DETAILED DESCRIPTION

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims.

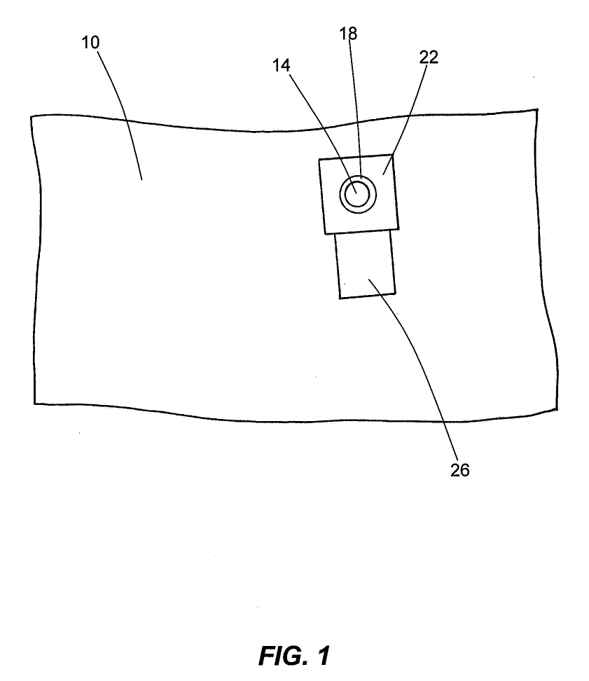

Turning now to FIG. 1, a front view of a vacuum bag 10 is shown. The vacuum bag is typically formed as a rectangular bag with an opening 14 formed therein. It is appreciated that other shapes of vacuum bags may be made as well. The vacuum bag 10 is often about 40 inches long and about 22 inches tall. The opening 14 may be formed about two inches in diameter so as to attach to the inlet of a canister vacuum (inside of the canister where the vacuum hose empties into the canister). A seal 18, formed of a material such as rubber, may be provided which improves the seal to the vacuum inlet, containing debris within the vacuum bag 10. The seal is typically a flat, thin disk surrounding the opening. A rigid reinforcement 22, such as a square or plastic or cardstock, may be provided to maintain the shape of the opening 14 and seal 18, ensuring a good seal to the vacuum inlet.

A closure seal 26 may also be provided. The closure seal 26 may be an adhesive lined piece of paper with a release paper thereon to prevent sticking to undesired surfaces. When the bag is full, the release paper is removed and the closure seal is folded over and stuck to the reinforcement 22, sealing the opening 14.

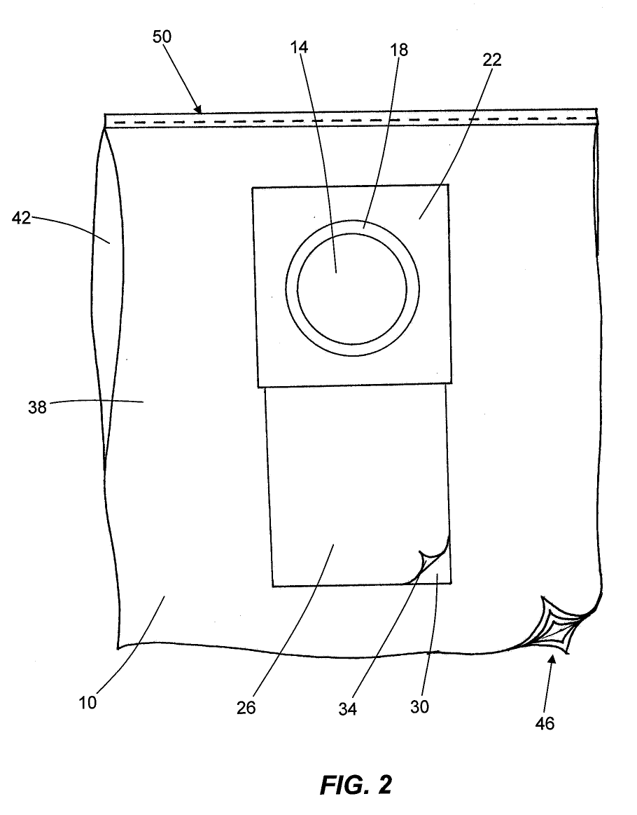

FIG. 2 shows a detailed view of a portion of the bag 10, better illustrating the opening 14, seal 18, rigid reinforcement 22, and closure seal 26. It can be seen how the closure seal 26 may include a adhesive lined layer 30 and a release layer 34. The front side 38 and back side 42 of the vacuum bag 10 may be formed of a plastic material such as polypropylene, etc. The plastic material may be a spun-bonded material, as such have good filtering properties.

As indicated at 46, the material may comprise multiple layers of material which are attached together (such as by heat fusing or sewing) and then used to form the vacuum bag 10. Multiple layers of material may filter better than a single thicker layer material. The vacuum bag 10 may be made by attaching the edges of the material together by sewing, heat fusing, etc., as is indicated at 50. The bag 10 is typically made large enough to extend from the bottom to the top of a vacuum canister and to wrap around the sides of the canister in the shape of a horseshoe.

The resulting vacuum bag is quite strong. A vacuum bag full of sheetrock dust or cement dust may easily weigh 75 pounds or more. The present vacuum bag may be lifted out of the vacuum full without tearing the bag. A further and important advantageous is that the vacuum bag 10 allows a person to vacuum up both wet and dry materials. Water does not destroy the bag, as it does to available vacuum bags. Unless retained by the solids in the bag 10, the water will typically seep through the bag and can be drained from the vacuum.

As all solids are securely held within the bag 10, a user may vacuum up liquids without need to change the bag or empty the vacuum first. Liquids may even pass through the vacuum bag 10, keeping the solids trapped in the bag. Thus, for example, if the bag is used to collect the slurry from wet cutting concrete (containing water and powdered cured concrete and rock) the bag will contain the powders and solids and some water, and some water will pass out of the bag. If the slurry contains much more water than solids, the water may even be drained from the vacuum using a drain port, allowing further use of the vacuum bag before discarding the full bag.

The vacuum bags may be made of different porosities of filter materials as is desired. Preferably, the vacuum bags 10 are made with a filter material having sufficiently fine pores to collect the majority of fine particulates, such as when a person is vacuuming sheetrock dust, concrete cutting dust, fine dirt, etc. The vacuum bags may be made with a fine enough filter material to be HEPA rated in collecting fine particulates. A currently preferred filter material retains particles with sizes down to about 0.5 micron.

The vacuum bag 10 is thus advantageous for both wet and dry use. For dry use, the bag 10 provides superior filtration and greatly improved strength and durability over paper vacuum bags. The vacuum bag 10 significantly reduces the dust in the vacuum exhaust and does not tear when full or when removed from the vacuum.

For wet use, the vacuum bag 10 allows the user to collect any wet materials or liquids. Any solids present in the liquids are trapped in the bag, eliminating the need to clean the vacuum canister afterwards. The bag 10 may be filled with wet materials without fear of the bag deteriorating. Additionally, the vacuum bag 10 may be placed in a damp or wet vacuum canister (as may often occur from previous use) without cleaning and drying the canister. Doing such would ruin a paper vacuum bag.

A person may thus use the wet/dry vacuum bag 10 of the present invention as a general purpose bag. The person may vacuum virtually any substance with the present bag without worry of the bag failing, or simply failing to adequately contain the substance. The person need not change the filter or reconfigure the vacuum between wet or dry materials, and need not clean the vacuum canister afterwards. Because the bag is disposable, there is no need to clean filter elements, as is often required with other types of vacuum filters. Cleaning filter elements may be particularly difficult on construction sites.

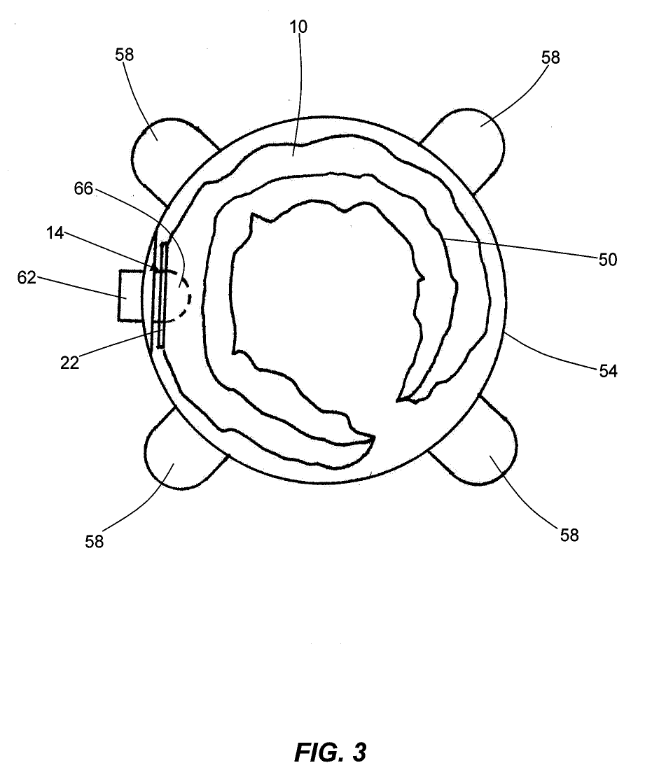

FIG. 3 shows a top view of the canister 54 of a canister vacuum with a vacuum bag 10 of the present invention therein. The canister 54 is typically a plastic cylindrical-shaped receptacle with an open top. The canister lid includes the vacuum motor and filters, power cord, switches, etc. The canister 54 is used to collect the debris collected while using the vacuum. Typically a canister vacuum includes roller feet 58 attached to the canister 54 to enable a user to easily move the vacuum. The canister 54 includes a connector 62 which connects to the vacuum hose (not shown) and which forms a conduit into the canister 54 to the inlet 66. The opening 14 fits over the inlet 66 and the rigid support 22 maintains the shape of the opening 14 and ensures a good seal to the inlet 66. Thus, debris collected by the vacuum passed through the hose, connector 62, inlet 66, and into the vacuum bag 10. When full, the vacuum bag 10 may be disposed of as has been discussed.

There is thus disclosed an improved wet/dry vacuum bag. It will be appreciated that numerous changes may be made to the present invention without departing from the scope of the claims.

What is claimed is:

1. A vacuum bag comprising:
a bag formed from a material which is not deteriorated by water; and
an inlet formed therein, the inlet being configured for attachment to a vacuum.

2. The vacuum bag of claim 1, wherein the bag is generally rectangular.

3. The vacuum bag of claim 1, wherein the inlet comprises a rubber inlet seal for sealing the bag to the vacuum.

4. The vacuum bag of claim 3, wherein the inlet comprises a rigid reinforcement member.

5. The vacuum bag of claim 1, wherein the bag is made of a spun-bonded plastic material.

6. The vacuum bag of claim 1, further comprising a closure seal for sealing a filled vacuum bag for disposal.

7. The vacuum bag of claim 6, wherein the closure seal comprises an adhesive lined planar member.

8. A vacuum bag comprising:
a vacuum bag configured for disposition in a canister vacuum, the vacuum bag being formed from a material which is water and air permeable and which is not adversely affected by contact with liquids;
a single opening formed in the vacuum bag, the opening being configured for attachment to the vacuum hose inlet in a canister vacuum; and
an inlet seal disposed around the single opening for sealing the opening to the vacuum inlet.

9. The vacuum bag of claim 8, wherein the opening is round and about 2 inches in diameter.

10. The vacuum bag of claim 8, wherein the inlet seal is formed from thin rubber sheet.

11. The vacuum bag of claim 8, further comprising a rigid reinforcement member disposed around the opening and configured for maintaining the size of the opening.

12. The vacuum bag of claim 8, further comprising a closure seal for sealing the opening when the vacuum bag is full.

13. The vacuum bag of claim 12, wherein the closure seal comprises an adhesive-lined flexible sheet.

14. The vacuum bag of claim 8, wherein the material comprises a plastic cloth.

15. The vacuum bag of claim 14, wherein the material comprises a spun-bonded material.

16. The vacuum bag of claim 14, wherein the material comprises multiple layers of material joined together.

17. The vacuum bag of claim 8, wherein the vacuum bag is about 40 inches long and about 22 inches tall.

18. The vacuum bag of claim 8, wherein the material is configured to collect debris of about 0.5 micron in size and larger.

19. A method of collecting wet debris comprising:
selecting a canister vacuum having a canister, an inlet into the canister, and a vacuum motor;
selecting a vacuum bag, the vacuum bag having a single opening of about two inches in diameter;
placing the vacuum bag into the canister;
placing the vacuum bag opening over the canister inlet; and
operating the vacuum to collect wet debris in the vacuum bag.

20. The method of claim 19, wherein the method comprises selecting a vacuum bag formed from a plastic material.

21. The method of claim 20, wherein the plastic material is configured to retain particles of about 0.5 micron and larger in size.
